(19) United States
(12) Patent Application Publication
(10) Pub. No.: US 2014/0200831 A1
(43) Pub. Date: Jul. 17, 2014

(54) Pipe Damage Interpretation System

(71) Applicants: David P. Smith, Anchorage, AK (US); Bonnie Powell, Johnstown, CO (US); Russell Powell, Johnstown, CO (US)

(72) Inventors: David P. Smith, Anchorage, AK (US); Bonnie Powell, Johnstown, CO (US); Russell Powell, Johnstown, CO (US)

(73) Assignee: SCHLUMBERGER TECHNOLOGY CORPORATION, Sugar Land, TX (US)

(21) Appl. No.: 13/982,094

(22) PCT Filed: Jan. 30, 2012
(86) PCT No.: PCT/US2012/023122

§ 371 Date: Oct. 9, 2013

Related U.S. Application Data
(60) Provisional application No. 61/437,370, filed on Jan. 28, 2011.

(51) Int. Cl. G01N 27/90

(52) U.S. Cl. CPC G01N 27/9046
USPC 702/38

(57) ABSTRACT

A technique facilitates evaluation of pipe. A sensor is positioned to examine a pipe and to obtain data on the pipe. The data obtained is analyzed on a processor-based system and compared to predetermined defect data. If the data obtained by the sensor sufficiently matches predetermined defect data, a defect is determined to enable performance of an appropriate action with respect to the pipe.

### BACKGROUND

Magnetic flux leakage (MFL) methods and/or techniques have been practiced using devices, e.g. internal robots or pigs, for inspecting substantially large outside diameter pipes for defects. More recently, MFL methods have been utilized for inspecting smaller diameter tubes from the outside rather than performing inspections via the traditional internal devices. Existing techniques, however, have not been successful in consistently identifying defects in various pipes, such as coiled tubing and drilling tubulars.

### SUMMARY

In general, the present disclosure provides a methodology and system for evaluating pipe. A sensor is positioned to examine a pipe and to obtain data on the pipe. The data obtained is analyzed on a processor-based system and compared to predetermined defect data. If the data obtained by the sensor sufficiently matches predetermined defect data, a defect is determined to enable performance of an appropriate action with respect to the pipe.

### BRIEF DESCRIPTION OF THE DRAWINGS

Certain embodiments will hereafter be described with reference to the accompanying drawings, wherein like reference numerals denote like elements. It should be understood, however, that the accompanying figures illustrate only the various implementations described herein and are not meant to limit the scope of various technologies described herein, and:

FIG. 1 is a schematic illustration of an example of a system for evaluating pipe, according to an embodiment of the disclosure;

FIG. 2 is a schematic illustration of a processor-based system for evaluating pipe data, according to an embodiment of the disclosure;

FIG. 3 is a graphical representation of data obtained from a sensor of the system for evaluating pipe, according to an embodiment of the disclosure; and

FIG. 4 is a graphical representation of a comparison of data obtained from a sensor of the system and predetermined defect data, according to an embodiment of the disclosure.

### DETAILED DESCRIPTION

In the following description, numerous details are set forth to provide an understanding of some illustrative embodiments of the present disclosure. However, it will be understood by those of ordinary skill in the art that the system and/or methodology may be practiced without these details and that numerous variations or modifications from the described embodiments may be possible.

The disclosure herein generally relates to a methodology and system for evaluating pipe. In some applications, the methodology and system is useful in the evaluation of wellsite equipment, including oilfield service equipment and oilfield tubular equipment, e.g. coiled tubing and drill pipe tubulars. Drill pipe tubulars may comprise various types of pipe, including drill pipe, heavyweight drill pipe, drill collars, and other drilling related tubulars.

In some applications, a sensor is employed to examine a pipe mounted on an appropriate fixture. The pipe and/or sensor may be moved relative to each other to obtain data on the pipe for determining whether the pipe has any defects. The sensor may comprise an individual sensor or a plurality of sensors of a single type or a plurality of types. In some applications, the sensor is placed at a location external to the pipe, although other applications may utilize a sensor within the pipe or a plurality of sensors located at exterior and interior positions with respect to the pipe. Although many types of sensors may be employed, an example of a sensor suitable for certain oilfield applications is an oilfield tubing pipe integrity detector.

Data obtained by the sensor with respect to the pipe is analyzed and compared to predetermined defect data. As described in greater detail below, the data may be analyzed on a processor-based system programmed to compare the data obtained by the sensor with the predetermined defect data and to determine any matches indicative of a defect or defects in the pipe. In some applications, the processor-based system is utilized in determining a specific type of a default in the pipe based on comparison to the predetermined defect data. If a defect is detected, an appropriate action may be taken with respect to the pipe. For example, the processor-based system may provide an indication that the pipe should be repaired or replaced. Upon detection of certain defects, the subject pipe may simply be discarded to eliminate the potential for pipe failure in a future operation due to the defect. In other applications, the pipe may be repaired or marked for other types of uses to mitigate the potential for pipe failure in a future operation. Use of the processor-based system also enables automatic analysis of the data in real time to facilitate rapid evaluation of pipe damage or other defects.

According to an example of the present methodology, potential pipe damage is evaluated in both coiled tubing and drilling pipe tubulars. Data on the pipe is obtained from a sensor in the form of a magnetic flux leakage detection device. The data is compared, e.g. matched, substantially in real-time to predetermined defect data accumulated on similar coiled tubing and/or drilling pipe tubulars. A processor-based system is used to perform the comparison (e.g. matching of data obtained by the sensor to predetermined defect data) to identify any damage or other defects to the pipe. The comparison of data also may be used to predict failure modes in the coiled tubing and/or drilling pipe tubulars.

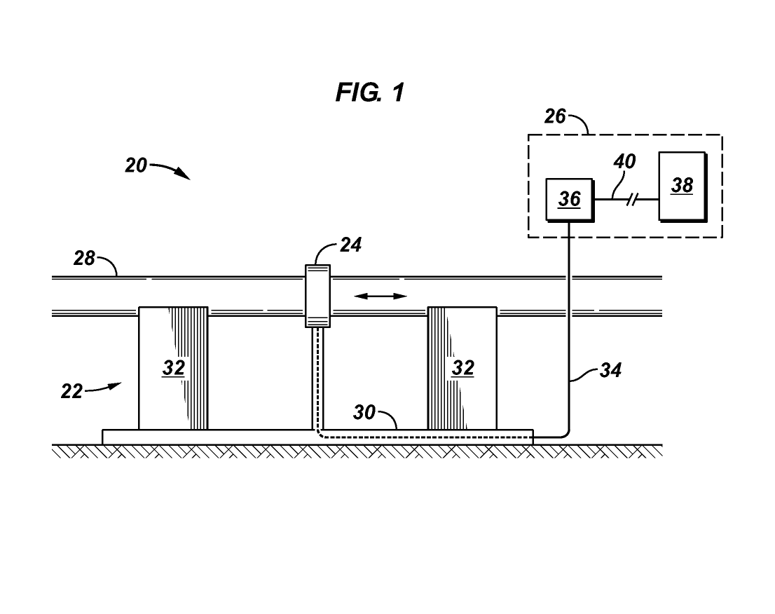

Referring generally to FIG. 1, an example of one type of application utilizing a pipe evaluation system to determine pipe damage or other defects is illustrated. The example is provided to facilitate explanation, and it should be understood that a variety of pipe evaluation systems, employed in well or non-well related applications, may utilize the methodology described herein. The evaluation system may comprise a variety of pipe mounting fixtures, sensor systems, data processing systems, and/or other components arranged in various configurations depending on the parameters of a specific evaluation application.

In FIG. 1, an embodiment of a pipe evaluation system 20 is illustrated as comprising a pipe mounting fixture 22, a sensor 24, and a processing system 26. The pipe mounting fixture 22 is designed to carry a pipe 28 in a manner that allows collection of data on the pipe 28 via sensor 24. Fixture 22 may comprise a base stand 30 and a mounting structure 32 which is designed to support pipe 28. In some applications, fixture 22 may comprise the pipe delivery system employed to deliver pipe downhole into a wellbore. Pipe 28 and sensor 24 also may undergo relative movement with respect to each other during accumulation of data on pipe 28. For example, fixture 22 may be designed to move pipe 28 along, e.g. through, sensor 24; or the pipe 28 may be conveyed by an external source, e.g. a powered coiled tubing reel, and slid along mounting structure 32 past sensor 24. However, sensor 24 also may be designed as a movable sensor which is moved along pipe 28 during movement of pipe 28 or while pipe 28 remains stationary on pipe mounting fixture 22.

In the example illustrated, sensor 24 may comprise a variety of types of sensors designed to detect a desired parameter or parameters related to pipe 28. In some embodiments sensor 24 may comprise a single sensor, while in other embodiments sensor 24 may comprise a plurality of sensors or sensor elements, e.g. magnetic flux leakage detection device probes. If sensor 24 comprises a plurality of sensors, the sensors may be positioned at different locations along pipe 28 and/or may be designed to sense different types of parameters. By way of example, sensor 24 may comprise an oilfield tubing pipe integrity detector. In a specific example, sensor 24 comprises a magnetic flux leakage protection device designed to detect anomalies in the pipe 28. For example, the sensor 24 may be designed to detect anomalies in coiled tubing and/or in drill pipe tubulars.

Data obtained by sensor 24 is transmitted via a communication line 34 to processing system 26. Communication line 34 may be in the form of a wired or wireless communication line designed to carry the signals from sensor 24 to processing system 26 for evaluation. The processing system 26 may be located proximate pipe mounting fixture 22 or it may be located in whole or in part at a remote location. For example, a first portion or portions 36 of processing system 26 may be located proximate fixture 22 while another portion or portions 38 of the processing system 26 may reside at a remote location. In some applications, the data from sensor 24 may be processed at least partially at both the proximate location and the remote location. However, in other applications the first component 36 may be used simply to transmit data for processing at the remote location on processing component 38.

Results obtained via the processing can be displayed or otherwise output to an operator at the remote location and/or returned to the proximate location. Communication between the proximate location and the remote location or locations, e.g. between components 36 and 38 of the processing system, can be implemented via a communication system 40. In some applications, the communication system 40 is designed to incorporate the Internet, thus allowing transfer of raw data, processed data, analyses, recommendations, instructions, evaluation adjustments, and other types of communications between desired locations and between components of the overall system 20.

The processing system 26 may reside at one location to process data, and results may be distributed to two or more locations. By way of example, processing system 26 may comprise a computer-based processing system designed to facilitate use of programming/software for analyzing data from sensor 24. Depending on the specific type or types of sensor 24, the data obtained may be processed according to different algorithms or strategies. Additionally, processing of the data obtained by sensors 24 may be adjusted to help determine whether specific types of defects occur in the pipe 28 being evaluated.

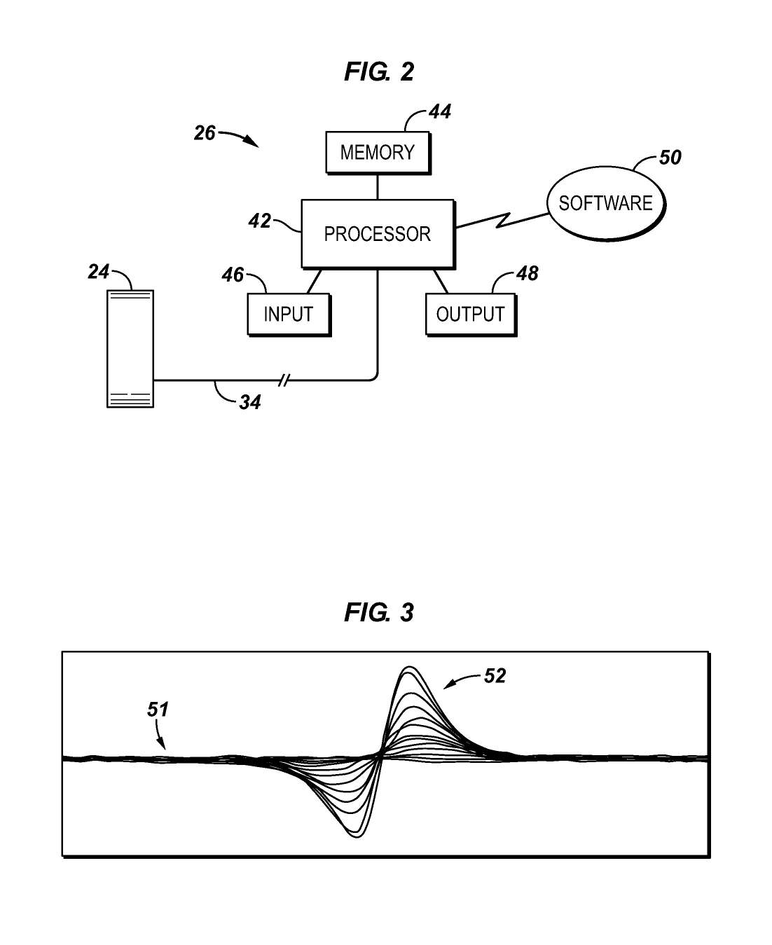

Referring generally to FIG. 2, an example of processing system 26 is illustrated. In this example, processing system 26 is in the form of a computer-based system having a processor 42, such as a central processing unit (CPU). The processor 42 is coupled with sensor 24 and is operatively employed to intake pipe data and then to process the data, e.g. run appropriate models and/or algorithms. For example, the processor 42 may be used to compare data obtained by sensors 24 with a predetermined defect data accumulated by prior analysis of pipe defects. The processor 42 also may be operatively coupled with a memory 44, an input device 46, and an output device 48. In some applications, processor 42 is used to run software 50, such as pattern matching software which compares data obtained from sensor 24 to data characteristics of the predetermined defect data to determine whether defects exist in the pipe 28. Software 50 also may comprise other types of models, algorithms, and programs depending on the types of sensors employed, types of defects evaluated, environments in which the pipe is used, and on other operational parameters.

By way of example, input device 46 may comprise a variety of devices, such as a keyboard, mouse, voice recognition unit, touchscreen, other input devices, or combinations of such devices. Output device 48 may comprise a visual and/or audio output device, such as a computer display, printer, monitor, or other display medium having a graphical user interface. As discussed above, the processing may be done on a single device or multiple devices on location, away from the pipe sensing location, or with some devices located on location and other devices located remotely. Once the desired algorithm, modeling, software, and/or other programming is stored in, for example, memory 44, processing system 26 may be operated in real time to evaluate data from sensor 24 for detecting defects or other parameters of pipe 28.

In an embodiment of the methodology, system 20 is designed as a pipe damage interpretation system. In this example, pipe 28 comprises coiled tubing or a drilling pipe tubular and sensor 24 comprises a magnetic flux imaging sensor. As pipe 28 and sensor 24 undergo relative movement with respect to each other, sensor 24 obtains magnetic flux imaging data. The data is captured utilizing at least one sensor probe, e.g. a plurality of probes, disposed on or near the pipe 28 during conveyance of the pipe 28, e.g. during conveyance of the pipe 28 across pipe mounting fixture 22. The data obtained by sensor 24 may comprise a variety of pipe data designed to provide an indication of a pipe defect. The data obtained by the magnetic flux imaging sensor 24 is compared to predetermined pipe defect data stored in a suitable storage medium, e.g. memory 44 of processing system 26. In this example, the predetermined pipe defect data may comprise acquired operational flux imaging and pipe defect data as well as flux imaging and pipe defect data obtained from laboratory inspections of coiled tubing and/or drilling pipe tubular samples.

The processing system 26 may be used to automatically compare the unknown or operational pipe defect data collected from sensor 24 with the predetermined defect data stored in, for example, memory 44. In this example, processor 42 is employed to automatically evaluate whether the pipe data matches the predetermined pipe defect data. By using comparison software 50, specific types of defects may be determined within the operational pipe defect data obtained via sensor 24.

In some oilfield applications, the pipe mounting fixture 22 may be part of a coiled tubing or drilling unit used to convey the coiled tubing or drilling pipe tubular past sensor 24. In this type of application, the sensor 24 also may comprise an oilfield tubing pipe integrity detector or other suitable sensor for obtaining data on the pipe 28 as it is conveyed past the sensor 24. If the sensor 24 is a magnetic flux leakage detection device, the sensor 24 is employed to obtain magnetic flux leakage data indicative of a defect along the pipe 28. Data indicative of an anomaly, e.g. a defect, in the pipe 28 is conveyed via communication line 34 to processing system 26. In this and other embodiments, the processing system 26 may again be used to run appropriate detection software, such as pattern matching software or other types of defect detection and analysis software. The processing system 26 may be programmed to determine if the intensity of the anomaly is sufficient to cause concern and/or to output data to an operator for review and evaluation.

Referring generally to FIG. 3, an example of data 51 obtained from sensor 24 from is illustrated graphically. In this example, an anomaly in the sensor data 51 is indicated by a graphical perturbation 52. The data associated with this anomaly 52, e.g. defect, may be captured by, for example, processing system 26 for further analysis. In some applications, the operational data obtained from sensor 24 may be compiled in the form of a data file including, for example, information related to the pipe 28, to the pipe location, to the type of job employing the pipe, and to the detected anomaly 52, e.g. pipe defect. The data 51 from sensor 24 may be matched with known defects as discussed in greater detail herein.

In some applications, the data 51 from sensor 24 may be combined with additional data to create a data file which may then be transmitted to a remote location for initial processing or for additional processing. The data file may be transmitted via the Internet or via another suitable communication system. Depending on the specifics of processing system 26, the data 51 may be transferred to memory 44 of a computer, a server, a central storage location, a pipe defect database, or to another suitable storage location for processing according to a suitable model, algorithm, or other type of program. For example, the data may be processed by comparing the sensor data to stored, predetermined defect data via pattern matching software 50.

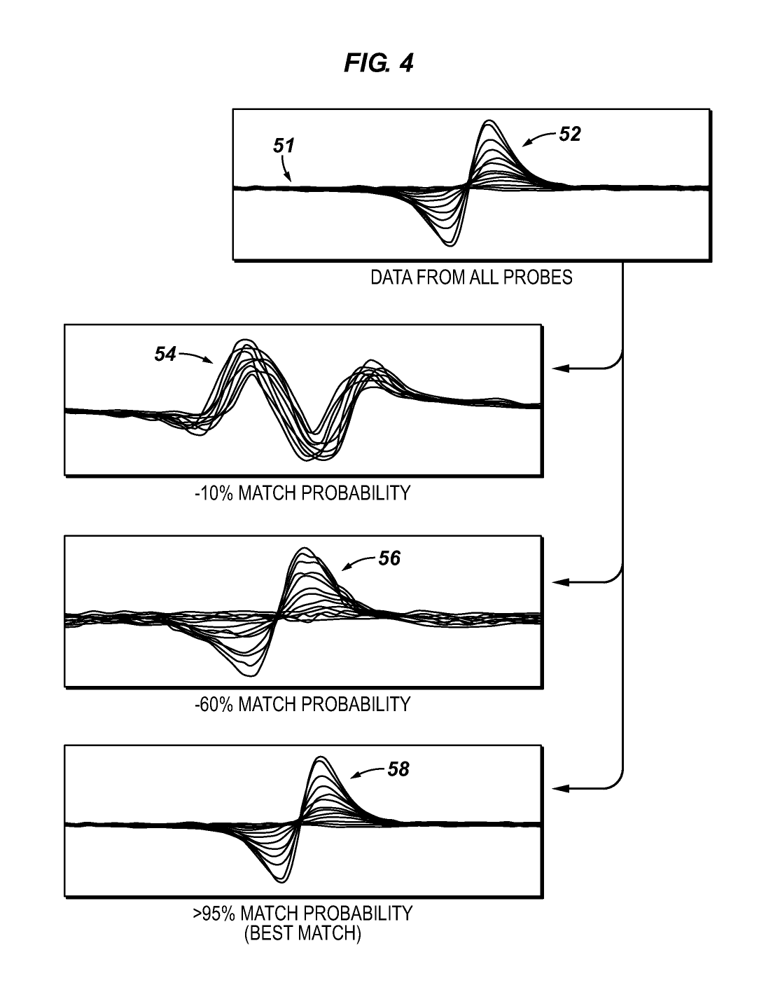

As illustrated graphically in FIG. 4, processing system 26 may be used to compare data 51 from sensor 24, e.g. operational flux imaging data, with predetermined pipe defect data. In the example illustrated, predetermined pipe defect data is illustrated as a plurality of known defect patterns 54, 56 and 58 to which the anomaly 52 is compared. The processing system 26 may be designed to determine the probability that the anomaly 52 detected by sensor 24 matches one of the stored, predetermined defect patterns 54, 56 or 58. If the probability is above a predetermined level, i.e. sufficiently high, then processing system 26 identifies the matching defect and outputs information via output 48. This enables performance of an action with respect to the pipe 28. For example, the pipe 28 can be repaired or removed to mitigate or substantially eliminate the potential for pipe failure in a future operation due to the defect. The corrective action also may be the output of information to an operator regarding performance of the pipe, e.g. prediction of a failure mode. In some applications, the corrective action, e.g. removal of a pipe component from a given operation, can be automated based on instructions output by processing system 26.

As indicated graphically in FIG. 4, the anomaly 52 detected by sensor 24 may be compared to known, predetermined defect patterns 54, 56 and 58 to assess the probability that anomaly 52 is a particular type of defect. In this example, the specific anomaly 52 is determined to have a 10% match probability with the defect patterns 54; a 60% match probability with the defect pattern 56; and a 95% match probability with the defect pattern 58. The match probabilities can be output to a suitable display or other output 48. If the 95% match probability is sufficiently high to establish a defect in the pipe 28, appropriate corrective action can be taken automatically or by an operator depending on the design of the overall system 20. In some applications, the processing system 26 is designed to generate a comprehensive report containing desired information. Examples of desired information may include whether the anomaly pattern 52 was suitably matched (e.g. did the anomaly pattern match a predetermined defect data pattern above a certain percentage of probability?); the specific area match in percentage; the types of failures that the anomaly pattern matched most closely, and historical information related to the most closely matched failures.

When sensor 24 comprises an operational flux imaging data sensor, the operational flux imaging data and pipe defect data are compared using parameter data which may comprise at least one of a combined probe “signature”; a probe number; Gauss amplitude; rise time; fall time; initial polarity; ringing effect; distance period of Gauss disruption(s); location of anomaly (depth); direction of pipe movement during detection; ovality of pipe at a specific depth; wall thickness of pipe at a specific depth; or other suitable parameter data. Additionally, the comparison may utilize various combinations of the parameter data; and the parameter data may be combined with other information, including fluid history (e.g. data from a suitable database on fluid utilized within the tubing system) and pipe history.

FIG. 4 illustrates three known defects which are compared to the detected anomaly 52 based on data from sensor 24. However, the storage device 44, e.g. computer memory, server memory, central storage location, or pipe defect database, may comprise predetermined defect data on many known defects. In some applications, hundreds and even thousands of known defect data patterns may be stored and developed for use in comparison to data obtained by sensor 24.

The data 51 obtained from sensor 24 and related to pipe defects may be submitted for comparison via processing system 26 and then added to the database of predetermined defect data. For example, data 51 from sensor 24 may be evaluated and used to determine defect patterns which are then captured, catalogued, and/or added to the database of predetermined defect data on, for example, memory 44. Additionally, data on the specific defect may be catalogued and stored according to specific pipes 28. For example, data may be catalogued and stored regarding specific defect areas of a given pipe. In some applications, a physical sample of the defect area of the pipe may be retained when the pipe, e.g. coiled tubing or drill pipe, is retired. This defect area from the physical sample may be examined to facilitate storage of accurate, predetermined defect data.

The system and methodology described herein may be employed in non-well related applications which require evaluation of pipe, e.g. tubing. Similarly, the system and methodology may be employed in many types of well applications, including evaluation of coiled tubing, production tubing, drill pipe tubulars, and other types of pipe used in downhole applications. Furthermore, various system components may be added, substituted and/or modified with respect to the overall evaluation system 20 to facilitate, for example, pipe handling, defect detection, and/or processing of data. Components of the sensor/sensor system 24, pipe mounting fixture 22, and/or processing system 26 may be added, substituted and/or modified to facilitate a given evaluation of a desired type of pipe.

Although only a few embodiments of the system and methodology have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method for evaluating pipe, comprising:
examining a pipe (28) with a sensor (24);
obtaining data (51) on the pipe (28) from examining the pipe (28) via the sensor (24);
analyzing the data (51) on a processor-based system (26) by comparing the data (51) to predetermined defect data (54, 56, 58);
determining a type of a defect (52) in the pipe (28) from the predetermined defect data (54, 56, 58); and
performing an action with respect to the pipe (28) to mitigate the potential for pipe failure in a future operation due to the defect of the pipe (28).

2. The method as recited in claim 1, wherein performing comprises discarding the pipe (28).

3. The method as recited in claim 1, wherein examining comprises examining coiled tubing (28).

4. The method as recited in claim 1, wherein examining comprises examining a drill pipe tubular (28).

5. The method as recited in claim 1, wherein examining comprises examining the pipe (28) with an oilfield tubing pipe integrity detector (24).

6. The method as recited in claim 1, wherein examining comprises examining the pipe (28) with a magnetic flux leakage detection device (24).

7. The method as recited in claim 1, wherein analyzing comprises performing at least a portion of the analyzing on a remote processor-based system (26) located remotely with respect to the pipe (28) and the sensor (24).

8. The method as recited in claim 1, wherein analyzing comprises running pattern matching software (50) on the processor-based system (26).

9. The method as recited in claim 1, wherein determining comprises determining the type of defect (52) based on a predetermined probability that the data on the defect (52) matches the predetermined defect data (54, 56, 58).

10. The method as recited in claim 1, wherein performing comprises predicting a failure mode of the pipe (28) based on the defect determined.

11. The method as recited in claim 1, wherein obtaining and analyzing comprise obtaining and analyzing substantially in real-time.

12. A method, comprising:
moving an oilfield pipe (28) relative to a sensor (24);
using the sensor (24) to obtain data (51) on the oilfield pipe (28);
comparing the data (51) to predetermined defect data (54, 56, 58) on a processor-based system (26); and
determining whether a defect (52) exists in the oilfield pipe (28) based on the comparison.

13. The method as recited in claim 12, further comprising taking corrective action with respect to the pipe (28) based on the type of the defect (52).

14. The method as recited in claim 13, wherein taking corrective action comprises removing the pipe (28) prior to use in an oilfield application.

15. The method as recited in claim 12, wherein moving the oilfield pipe (28) comprises moving the oilfield pipe (28) along an oilfield tubing pipe integrity detector (24).

16. The method as recited in claim 12, further comprising using the processor-based system (26) at least in part at a remote location accessed via the Internet (40).

17. A system for evaluating pipe, comprising:
a fixture (22) for holding a pipe (28) relative to a sensor (24); and
a processor-based system (26) comprising a data storage (44) that contains predetermined defect data (54, 56, 58), the processor-based system (26) being operatively coupled with the sensor (24) to obtain data (51) on the pipe (28) and to compare the data (51) to the predetermined defect data (54, 56, 58), the processor-based system (26) outputting a defect type (52) if the data (51) sufficiently matches the predetermined defect data (54, 56, 58) to determine the defect type (52) with sufficient probability.

18. The system as recited in claim 17, wherein the processor-based system (26) comprises pattern matching software (50) used in comparing the data (52) to the predetermined defect data (54, 56, 58).

19. The system as recited in claim 17, wherein the fixture (22) enables relative movement of the sensor (24) and coiled tubing (28).

20. The system as recited in claim 17, wherein the fixture (22) enables relative movement of the sensor (24) and a drill pipe tubular (28).
